(19) United States
(12) Patent Application Publication
(10) Pub. No.: US 2021/0405460 A1
(43) Pub. Date: Dec. 30, 2021

(54) FLEXIBLE DISPLAY PANEL, METHOD OF MANUFACTURING THEREOF, AND DISPLAY DEVICE

(71) Applicant: TCL CHINA STAR OPTOELECTRONICS TECHNOLOGY CO., LTD., Shenzhen, Guangdong (CN)

(72) Inventor: Yongchao ZHAO, Shenzhen (CN)

(21) Appl. No.: 16/631,888

(22) PCT Filed: Dec. 20, 2019
(86) PCT No.: PCT/CN2019/126898

§ 371 Date: Jan. 17, 2020

(30) Foreign Application Priority Data
Dec. 11, 2019 (CN) 201911265589.7

(51) Int. Cl. G02F 1/1337; G09F 9/30

(52) U.S. Cl. CPC G02F 1/133723; G09F 9/301; G02F 1/133788

(57) ABSTRACT

A flexible display panel, a method manufacturing thereof, and a display device are provided. The flexible display panel includes a first substrate, a first alignment film, a second substrate, a second alignment film, and a liquid crystal layer. When a current is applied to the first alignment film and the second alignment film, liquid crystals in the first liquid crystal layer have a first inclination angle with the first alignment film, and have a second inclination angle with the second alignment film. When the first inclination angle is 90°, the second inclination angle is less than 90°; and when the second inclination angle is 90°, the first inclination angle is less than 90°.

### BACKGROUND OF INVENTION

### Field of Invention

The present invention relates to the field of display technology, and more particularly, to a flexible display panel, a method of manufacturing thereof, and a display device.

### Description of Prior Art

With development of technology, various displays are also widely used in daily life. Compared with flat displays, curved displays have a wide viewing angle range and a wide field viewing, so they are often used to display wide-angle images. The curved displays have a curve property so as to avoid reflection interference from light sources on both sides. The curved displays are curved structures and have a radius of curvature. When the user watches the curved display at a focus point, the user's view angle is equal to the curved display, which can reduce a burden on eyes.

The curved display panels have a curve property, which makes an appearance of the displays to be more beautiful, and can obtain a larger display area in a limited space. Meanwhile, the curved display panels have a wider viewing angle, and it can bring more realistic paintings. The curved display panels are now popular in the market. However, the curved display panels are manufactured by combining normal flat display screens and curved backlights.

Traditional VA-type curved display panels can be found obvious black clusters on the left and right sides of the curved part when the panels are in a bending state, that is, the phenomenon of uneven brightness (Mura) is occurred, which seriously affects the viewing quality of the panels. By observing the black clusters areas and normal areas, it can be found uneven brightness areas, abnormal alignment, and the presence of obvious dark streaks, which generates of the black clusters.

Specifically, FIG. 1 is a schematic view of a conventional curved display panel 90 in a planar state. Referring to FIG. 1, the curved display panel 90 comprises an upper substrate 91, a lower substrate 92, and a liquid crystal layer 93 between the upper substrate 91 and the lower substrate 92. The liquid crystal layer 93 comprises a first liquid crystal layer 931 adjacent to the upper substrate 91 and a second liquid crystal layer 93 adjacent to the lower substrate 92. When a current is applied to the curved display panel 90, all liquid crystals in the liquid crystal layer 93 are deflected under an electric field. The deflection directions of the liquid crystals are identical, and the deflection angles of the liquid crystals are also identical, so that the brightness in different regions is consistent, and uneven brightness phenomenon is avoided.

Referring to FIG. 2, it is a schematic view of the curved display panel 90 shown in FIG. 1 in a curved state. Deflection directions and deflection angles of the first liquid crystal layer 931 and the second liquid crystal layer 932 are remain unchanged. Since the upper substrate 91 and the lower substrate 92 are relatively displaced, the first liquid crystal layer and the second liquid crystal layer are also relatively displaced. In a part of the display panel 90, the first liquid crystal layer and the second liquid crystal layer have a same deflection angle, but the deflection directions are opposite, and thus a part of the panel display area corresponding to the area has dark streaks, black clusters in the grayscale state, and uneven brightness.

Therefore, it is necessary to provide a new flexible display panel, a method of manufacturing thereof, and a display device to solve the problems in the prior art.

### SUMMARY OF INVENTION

A flexible display panel, a method of manufacturing thereof, and a display device are provided, which can ensure that the liquid crystals on both sides of the array substrate and the color filter substrate cannot form inclination angles in different directions after the flexible display panel is bent. Therefore, the problem of uneven brightness of the curved display panels can be solved.

A flexible display panel comprises a first substrate, a first alignment film, a second substrate, a second alignment film, and a liquid crystal layer. The first alignment film is disposed on a side surface of the first substrate. The second substrate is opposite to the first substrate. The second alignment film is disposed on a surface of the second substrate facing the first substrate, and is opposite to the first alignment film. The liquid crystal layer is disposed between the first alignment film and the second alignment film. The liquid crystal layer comprises a first liquid crystal layer adjacent to the first substrate and corresponding to the first alignment film, and a second liquid crystal layer adjacent to the second substrate and corresponding to the second alignment film. When a current is applied to the first alignment film and the second alignment film, liquid crystals in the first liquid crystal layer have a first inclination angle with the first alignment film, and have a second inclination angle with the second alignment film. When the first inclination angle is 90°, the second inclination angle is less than 90°; and when the second inclination angle is 90°, the first inclination angle is less than 90°.

In one embodiment, material of the first alignment film or the second alignment film comprises a vertical alignment polyimide.

In one embodiment, the second inclination angle is 60° to 89°.

In one embodiment, the first substrate is an array substrate, and the second substrate is a color filter substrate.

In one embodiment, when the flexible display panel is bent, the first liquid crystal layer and the second liquid crystal layer are displaced while the first inclination angle and the second inclination angle are unchanged.

A display device comprises a flexible display panel, and the flexible display panel comprises a first substrate, a first alignment film, a second substrate, a second alignment film, and a liquid crystal layer. The first alignment film is disposed on a side surface of the first substrate. The second substrate is opposite to the first substrate. The second alignment film is disposed on a surface of the second substrate facing the first substrate, and is opposite to the first alignment film. The liquid crystal layer is disposed between the first alignment film and the second alignment film. The liquid crystal layer comprises a first liquid crystal layer adjacent to the first substrate and corresponding to the first alignment film and a second liquid crystal layer adjacent to the second substrate and corresponding to the second alignment film. When a current is applied to the first alignment film and the second alignment film, liquid crystals in the first liquid crystal layer have a first inclination angle with the first alignment film, and have a second inclination angle with the second alignment film. When the first inclination angle is 90°, the second inclination angle is less than 90°; and when the second inclination angle is 90°, the first inclination angle is less than 90°.

A method of manufacturing a flexible display panel comprises following steps:

forming a first alignment film on a side surface of a first substrate, and the first alignment film forms a first inclination angle of a liquid crystal corresponding to the first alignment film;

forming a second alignment film on a side surface of a second substrate, and the second alignment film forms a second inclination angle of a liquid crystal corresponding to the second alignment film;

aligning the first alignment film or the second alignment film, and the first inclination angle or second inclination angle is decreased;

fitting the first substrate and the second substrate, and the first alignment film is opposite to the second alignment film; and

forming a liquid crystal layer by injecting liquid crystals between the first substrate and the second substrate, wherein the liquid crystal layer comprises a first liquid crystal layer corresponding to the first alignment film and a second liquid crystal layer corresponding to the second alignment film. The liquid crystals in the first liquid crystal layer have a first inclination angle with the first alignment film, and has a second inclination angle with the second alignment film. When the first inclination angle is 90°, the second inclination angle is less than 90°. When the second inclination angle is 90°, the first inclination angle is less than 90°.

In one embodiment, material of the first alignment film or the second alignment film comprises a vertical alignment polyimide.

In one embodiment, the first alignment film or the second alignment film is aligned by polarized ultraviolet light irradiation.

In one embodiment, before the step of forming a first alignment film further comprises a step of forming a first substrate; before the step of forming a second alignment film further comprises a step of forming a second substrate; and the first substrate is an array substrate, and the second substrate is a color filter substrate.

A flexible display panel, a method of manufacturing thereof, and a display device are provided. Liquid crystals in the first liquid crystal layer have a first inclination angle with the first alignment film, and has a second inclination angle with the second alignment film. When the first inclination angle is 90°, the second inclination angle is less than 90°; and when the second inclination angle is 90°, the first inclination angle is less than 90°. It is ensured that the first inclination angle and second inclination angle are unchanged when the panel is bent, and the liquid crystals on both sides of the first substrate and the second substrate do not form inclination angles in different directions. Therefore, the problem of uneven brightness of the curved surface of the panel can be solved.

### BRIEF DESCRIPTION OF DRAWINGS

FIG. 1 is a schematic view of a conventional curved display panel in a planar state.

FIG. 2 is a schematic view of the curved display panel shown in FIG. 1 in a curved state.

FIG. 3 is a schematic view of a flexible display panel in a planar state according to one embodiment of the present invention.

FIG. 4 is a schematic view of the flexible display panel in a bending state according to one embodiment of the present invention.

FIG. 5 is a flowchart of a method of manufacturing a flexible display panel according to one embodiment of the present invention.

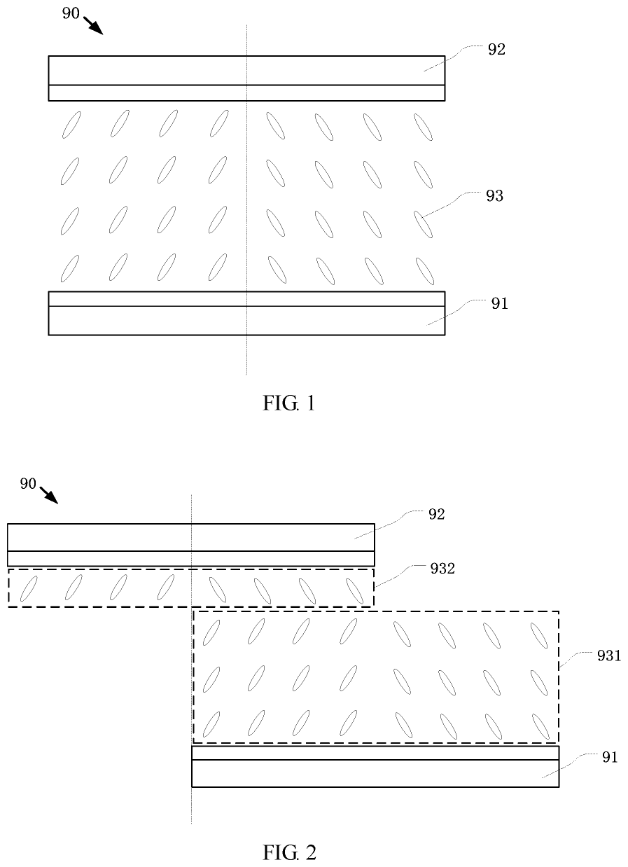

### REFERENCE NUMERALS

first substrate 1; the liquid crystal layer 2; the second substrate 3; flexible display panel 10; first alignment film 11; first liquid crystal layer 21; second liquid crystal layer 22; and second alignment film 31.

### DETAILED DESCRIPTION OF PREFERRED EMBODIMENTS

The preferred embodiments of the present invention are described in detail below with reference to the accompanying drawings. Those skilled persons in the art will easily understand how to implement the invention. The invention can be implemented by the embodiments, so that the technical content of the disclosure will be clear, so that those skilled persons in the art will understand how to implement the invention. The present invention may be accomplished in many different embodiments, and the scope of the invention is not limited to the embodiments described herein.

In the description of this application, it should be understood that the terms “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, “counterclockwise”, etc. or the positional relationship is based on the orientation or positional relationship shown in the drawings, and is only for the convenience of describing this application and simplifying the description, and does not indicate or imply that the device or element referred to must have a specific orientation, structure and operation in a specific orientation. Therefore, it cannot be understood as a limitation on this application. In addition, the terms “first” and “second” are used for descriptive purposes only and cannot be understood as indicating or implying relative importance or implicitly indicating the number of technical features indicated. Therefore, the features defined as “first” and “second” may explicitly or implicitly include one or more of the features. In the description of the present application, the meaning of “a plurality” is two or more, unless it is specifically defined otherwise.

In one embodiment, a display device is provided, and the display device comprises a flexible display panel.

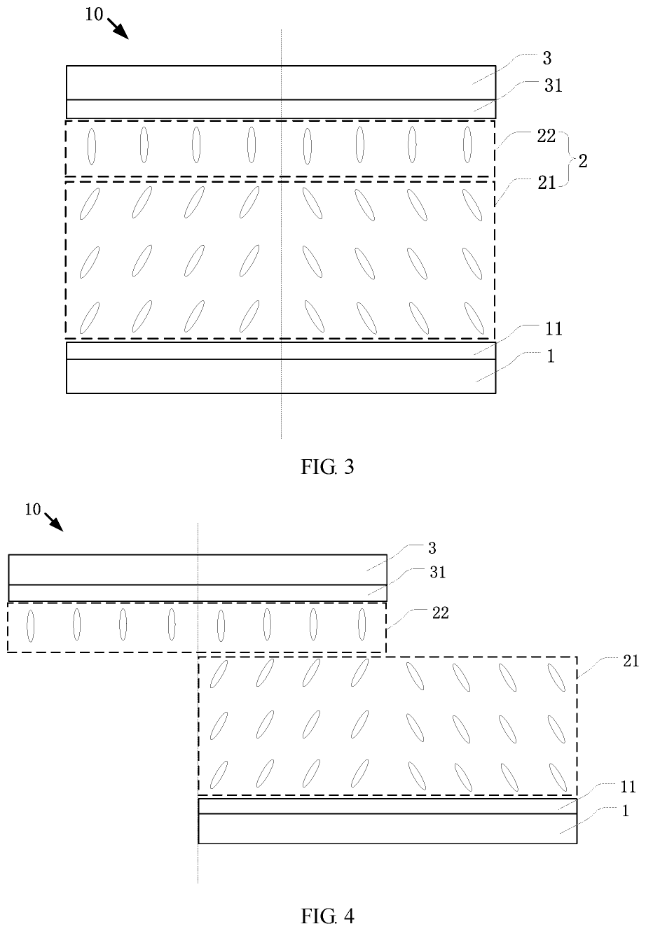

In first embodiment, referring to FIG. 3 and FIG. 4, the first embodiment of the present invention provides a flexible display panel 10. FIG. 3 is a schematic view of the flexible display panel 10 in a planar state according to one embodiment of the present invention. FIG. 4 is a schematic view of the flexible display panel 10 in a bending state according to one embodiment of the present invention.

The flexible display panel 10 comprises a first substrate 1, a first alignment film 11, a second substrate 3, a second alignment film 31, and a liquid crystal layer 2. The first alignment film 11 is disposed on a side surface of the first substrate 1. The second substrate 3 is opposite to the first substrate 1. The second alignment film 31 is disposed on a surface of the second substrate 3 facing the first substrate 1, and is opposite to the first alignment film 11. The liquid crystal layer 21 is disposed between the first alignment film 11 and the second alignment film 31. The liquid crystal layer 21 comprises a first liquid crystal layer 21 adjacent to the first substrate 1 and the first liquid crystal layer 21 corresponds to the first alignment film 11; and a second liquid crystal layer 22 adjacent to the second substrate 3 and the second liquid crystal layer 22 corresponds to the second alignment film 31. When a current is applied to the first alignment film 11 and the second alignment film 31, the liquid crystals in the first liquid crystal layer 21 have a first inclination angle with the first alignment film 11, and the liquid crystals in the second liquid crustal layer 22 have a second inclination angle with the second alignment film 31. When the first inclination angle is 90°, the second inclination angle is less than 90°.

In one embodiment, the first inclination angle and the second inclination angle are angles between an arrangement direction of liquid crystals in the liquid crystal layer 21 and a plane of the first alignment film 11 or the second alignment film 31.

In one embodiment, material of the first alignment film 11 or the second alignment film 31 comprises a vertical alignment polyimide. The inclination angle is 90° when the alignment film is not processed.

One of the first alignment film 11 and the second alignment film 31 is irradiated with polarized ultraviolet light so that the liquid crystals in the liquid crystal layer 21 corresponding thereto form an acute angle, and the other not irradiated with polarized ultraviolet light is kept the inclination angle of 90°. It can be ensured that when the flexible display panel 10 is bent, the first liquid crystal layer 21 and the second liquid crystal layer 22 on the two sides of the first substrate 1 and the second substrate 3 may not form inclination angles in different directions. That is, the first inclination angle and the second inclination angle are opposite to each other are avoided. Therefore, the problem of uneven brightness of the curved surface of the panel can be solved.

In one embodiment, the pre-inclination angle is 60° to 89°, and preferably 70°, 75°, 80°, and 85°.

In this embodiment, the first substrate 1 is preferably an array substrate, and the second substrate 3 is preferably a color filter substrate. More preferably, the first alignment film 11 is irradiated with polarized ultraviolet light so that the liquid crystal in the first liquid crystal layer 21 forms the first inclination angle to be an acute angle, and the second alignment film 31 is not irradiated. Therefore, it is ensured that the second inclination angle of the liquid crystal of the second liquid crystal layer 22 on a side of the second alignment film 31 is maintained at 90°. Therefore, the first inclination angle and the second inclination angle are unchanged before/after the flexible display panel 10 is bent. The second inclination angle is maintained at 90°, even if the first inclination direction of the first liquid crystal layer 21 is different, the first inclination angle and the second inclination angle are not overlapped with each other to generate black clusters which cause uneven brightness. Therefore, the problem of uneven brightness of the curved surface of the panel can be solved.

Specifically, as shown in FIG. 4, when the flexible display panel 10 is bent, the first substrate 1 and the second substrate 3 are displaced, and the first liquid crystal layer 21 and the second liquid crystal layer 22 are also displaced. The arrangement direction of the liquid crystals in the first liquid crystal layer 21 and the second liquid crystal layer 22 is unchanged, and the inclination angle of the liquid crystals in the second liquid crystal layer 22 is maintained at 90°. Even if the first inclination direction of the first liquid crystal layer 21 is different, the first inclination angle and the second inclination angle are not overlapped with each other to generate black clusters which cause uneven brightness. Therefore, the problem of uneven brightness of the curved surface of the panel can be solved.

In one embodiment of the present invention, a display device is provided. The display device comprises a flexible display panel 10. The flexible display panel 10 comprises a first substrate 1, a first alignment film 11, a second substrate 3, a second alignment film 31, and a liquid crystal layer 2. The first alignment film 11 is disposed on a side surface of the first substrate 1. The second substrate 3 is disposed opposite to the first substrate 1.

The second alignment film 31 is disposed on a side surface of the second substrate 3 facing the first substrate 1, and is opposite to the first alignment film 11. The liquid crystal layer 21 is disposed between the first alignment film 11 and the second alignment film 31. The liquid crystal layer 21 comprises a first liquid crystal layer 21 adjacent to the first substrate 1 and corresponding to the first alignment film 11 and a second liquid crystal layer 22 adjacent to the second substrate 3 and corresponding to the second alignment film 31. When a current is applied to the first alignment film 11 and the second alignment film 31, the liquid crystals in the first liquid crystal layer 21 have a first inclination angle with the first alignment film 11, and the liquid crystals in the second liquid crustal layer 22 have a second inclination angle with the second alignment film 31. When the first inclination angle is 90°, the second inclination angle is less than 90°.

The flexible display panel 10 of the display device is identical to the flexible display panel 10 described above. For details, please refer to the above content, which is not described herein.

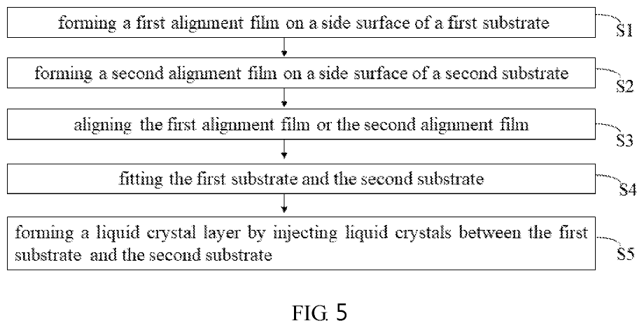

Referring to FIG. 5, a method of manufacturing a flexible display panel 10 is further provided, and the method comprises following steps:

step S1, forming a first alignment film 11 on a side surface of a first substrate 1, and the first alignment film 11 forms a first inclination angle of a liquid crystal corresponding to the first alignment film 11;

step S2, forming a second alignment film 31 on a side surface of a second substrate 3, and the second alignment film 31 forms a second inclination angle of a liquid crystal corresponding to the second alignment film 31;

step S3, aligning the first alignment film 11 or the second alignment film 31, and the first inclination angle or second inclination angle is decreased;

step S4, fitting the first substrate 1 and the second substrate 3, and the first alignment film 11 is opposite to the second alignment film 31; and

step S5, forming a liquid crystal layer 2 by injecting liquid crystals between the first substrate 1 and the second substrate 3, and the liquid crystal layer 2 comprises a first liquid crystal layer 21 corresponding to the first alignment film 11 and a second liquid crystal layer 22 corresponding to the second alignment film 31. The liquid crystals in the first liquid crystal layer 21 have a first inclination angle with the first alignment film 11, and the liquid crystals in the second liquid crustal layer 22 have a second inclination angle with the second alignment film 31. When the first inclination angle is 90°, the second inclination angle is less than 90°.

In one embodiment, material of the first alignment film 11 or the second alignment film 31 comprises a vertical alignment polyimide. The inclination angle is 90° when the alignment film is not processed.

In one embodiment, the first inclination angle and the second inclination angle are angles between an arrangement direction of liquid crystals in the liquid crystal layer 21 and a plane of the first alignment film 11 or the second alignment film 31.

One of the first alignment film 11 and the second alignment film 31 is irradiated with polarized ultraviolet light so that the liquid crystals in the liquid crystal layer 21 corresponding thereto form an acute angle, and the other not irradiated with polarized ultraviolet light is kept the inclination angle of 90°. It can be ensured that when the flexible display panel 10 is bent, the liquid crystal on the two sides of the first substrate 1 and the second substrate 3 may not form inclination angles in different directions. Therefore, the problem of uneven brightness of the curved surface of the panel can be solved.

In one embodiment, the pre-inclination angle is 60° to 89°, and preferably 70°, 75°, 80°, and 85°.

In one embodiment, before the step of forming a first alignment film 11 further comprises a step of forming a first substrate 1; and before the step of forming a second alignment film 31 further comprises a step of forming a second substrate 3.

Preferably, the first substrate 1 is an array substrate, and the second substrate 3 is a color filter substrate. More preferably, the first alignment film 11 is irradiated with polarized ultraviolet light so that the liquid crystal in the first liquid crystal layer 21 forms the first inclination angle to be an acute angle, and the second alignment film 31 is not irradiated. Therefore, it is ensured that the second inclination angle of the liquid crystal of the second liquid crystal layer 22 on a side of the second alignment film 31 is maintained at 90°. Therefore, the first inclination angle and the second inclination angle are unchanged before/after the flexible display panel 10 is bent. The second inclination angle is maintained at 90°, even if the first inclination direction of the first liquid crystal layer 21 is different, the first inclination angle and the second inclination angle are not superimposed on each other to generate black clusters which causes uneven brightness. Therefore, the problem of uneven brightness of the curved surface of the panel can be solved.

Specifically, as shown in FIG. 4, when the flexible display panel 10 is bent, the first substrate 1 and the second substrate 3 are displaced, and the first liquid crystal layer 21 and the second liquid crystal layer 22 are also displaced.

The arrangement direction of the liquid crystals in the first liquid crystal layer 21 and the second liquid crystal layer 22 is unchanged, and the inclination angle of the liquid crystals in the second liquid crystal layer 22 is maintained at 90°. Even if the first inclination direction of the first liquid crystal layer 21 is different, the first inclination angle and the second inclination angle are not overlapped with each other to generate black clusters which cause uneven brightness. Therefore, the problem of uneven brightness of the curved surface of the panel can be solved.

In second embodiment, it comprises most of the technical features of the first embodiment, and the difference is that the second alignment film 31 is irradiated with polarized ultraviolet light so that the liquid crystal in the second liquid crystal layer 22 forms the second inclination angle to be an acute angle. and the second alignment film 31 is not irradiated, which is different to the first embodiment. In that first embodiment, the first alignment film 11 is irradiated with polarized ultraviolet light so that the liquid crystal in the first liquid crystal layer 21 forms the first inclination angle to be an acute angle.

Correspondingly, in the flexible display panel 10 of the second embodiment, when the first alignment film 11 and the second alignment film 31 are applied with current, the second inclination angle is 90°, and the first inclination angle is less than 90°. Alternatively, the first inclination angle is 90°, and the second inclination angle is less than 90° in the first embodiment.

Similarly, in step S5 of the method of manufacturing the flexible display panel 10 in the second embodiment, the second inclination angle is 90°, and the first inclination angle is less than 90°. Alternatively, the first inclination angle of is 90° in the step S5 of the first embodiment, and the second inclination angle is less than 90°.

Of course, it can also be simply understood that in the second embodiment, the second substrate 3 is preferably an array substrate, and the first substrate 1 is preferably a color filter substrate. Compared with the first embodiment, only the positions of the array substrate and the color filter substrate are reversed with each other. It does not cause the first inclination angle and the second inclination angle to overlap with each other to generate black clusters, thereby causing uneven brightness. Therefore, the problem of uneven brightness of the curved surface of the panel can be solved, and details are not described herein.

In the above embodiments, the description of each embodiment has its own emphasis. For a part that is not described in detail in one embodiment, reference may be made to related descriptions in other embodiments.

The flexible display panel 10, the display device, and the method of manufacturing the flexible display panel 10 in the embodiments of the present invention have been described in detail above. In the above, the present application has been described in the above preferred embodiments, but the preferred embodiments are not intended to limit the scope of the invention, and a person skilled in the art may make various modifications without departing from the spirit and scope of the application. The scope of the present application is determined by claims.

What is claimed is:

1. A flexible display panel, comprising:
a first substrate;
a first alignment film disposed on a side surface of the first substrate;
a second substrate opposite to the first substrate;
a second alignment film disposed on a surface of the second substrate facing the first substrate, and opposite to the first alignment film; and
a liquid crystal layer disposed between the first alignment film and the second alignment film, wherein the liquid crystal layer comprises:
a first liquid crystal layer adjacent to the first substrate and corresponding to the first alignment film; and
a second liquid crystal layer adjacent to the second substrate and corresponding to the second alignment film;
wherein when a current is applied to the first alignment film and the second alignment film, liquid crystals in the first liquid crystal layer have a first inclination angle with the first alignment film, and have a second inclination angle with the second alignment film; and
wherein when the first inclination angle is 90°, the second inclination angle is less than 90°; and when the second inclination angle is 90°, the first inclination angle is less than 90°.

2. The flexible display panel according to claim 1, wherein material of the first alignment film or the second alignment film comprises a vertical alignment polyimide.

3. The flexible display panel according to claim 1, wherein the second inclination angle is 60° to 89°.

4. The flexible display panel according to claim 1, wherein the first substrate is an array substrate, and the second substrate is a color filter substrate.

5. The flexible display panel according to claim 1, wherein when the flexible display panel is bent, the first liquid crystal layer and the second liquid crystal layer are displaced while the first inclination angle and the second inclination angle are unchanged.

6. A display device, comprising a flexible display panel, wherein the flexible display panel comprises:
a first substrate;
a first alignment film disposed on a side surface of the first substrate;
a second substrate opposite to the first substrate;
a second alignment film disposed on a surface of the second substrate facing the first substrate, and opposite to the first alignment film; and
a liquid crystal layer disposed between the first alignment film and the second alignment film, wherein the liquid crystal layer comprises:
a first liquid crystal layer adjacent to the first substrate and corresponding to the first alignment film; and
a second liquid crystal layer adjacent to the second substrate and corresponding to the second alignment film;
wherein when a current is applied to the first alignment film and the second alignment film, liquid crystals in the first liquid crystal layer have a first inclination angle with the first alignment film, and have a second inclination angle with the second alignment film; and
wherein when the first inclination angle is 90°, the second inclination angle is less than 90°; and when the second inclination angle is 90°, the first inclination angle is less than 90°.

7. The flexible display panel according to claim 6, wherein material of the first alignment film or the second alignment film comprises a vertical alignment polyimide.

8. The flexible display panel according to claim 6, wherein the second inclination angle is 60° to 89°.

9. The flexible display panel according to claim 6, wherein the first substrate is an array substrate, and the second substrate is a color filter substrate.

10. The flexible display panel according to claim 6, wherein when the flexible display panel is bent, the first liquid crystal layer and the second liquid crystal layer are displaced while the first inclination angle and the second inclination angle are unchanged.

11. A method of manufacturing a flexible display panel, comprising following steps:
forming a first alignment film on a side surface of a first substrate, wherein the first alignment film forms a first inclination angle of a liquid crystal corresponding to the first alignment film;
forming a second alignment film on a side surface of a second substrate, wherein the second alignment film forms a second inclination angle of a liquid crystal corresponding to the second alignment film;
aligning the first alignment film or the second alignment film, wherein the first inclination angle or second inclination angle is decreased;
fitting the first substrate and the second substrate, wherein the first alignment film is opposite to the second alignment film; and
forming a liquid crystal layer by injecting liquid crystals between the first substrate and the second substrate, wherein the liquid crystal layer comprises a first liquid crystal layer corresponding to the first alignment film and a second liquid crystal layer corresponding to the second alignment film;
wherein the liquid crystals in the first liquid crystal layer have a first inclination angle with the first alignment film, and has a second inclination angle with the second alignment film; and
wherein when the first inclination angle is 90°, the second inclination angle is less than 90°; and when the second inclination angle is 90°, the first inclination angle is less than 90°.

12. The method of manufacturing a flexible display panel according to claim 11, wherein material of the first alignment film or the second alignment film comprises a vertical alignment polyimide.

13. The method of manufacturing a flexible display panel according to claim 12, wherein the first alignment film or the second alignment film is aligned by polarized ultraviolet light irradiation.

14. The method of manufacturing a flexible display panel according to claim 11, wherein before the step of forming a first alignment film further comprises a step of forming a first substrate;
wherein before the step of forming a second alignment film further comprises a step of forming a second substrate; and
wherein the first substrate is an array substrate, and the second substrate is a color filter substrate.
